(19) United States
(12) Patent Application Publication
(10) Pub. No.: US 2005/0013218 A1
(43) Pub. Date: Jan. 20, 2005

(54) Information storage medium having a plurality of data storing units and apparatus and method for data recording and/or reproducing

(75) Inventors: Kyung-geun Lee, Gyeonggi-do (KR); Han-kook Choi, Gyeonggi-do (KR); Myong-do Ro, Gyeonggi-do (KR); In-sik Park, Gyeonggi-do (KR); Jae-seong Shim, Seoul (KR); Jung-wan Ko, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/846,925

(22) Filed: May 17, 2004

(30) Foreign Application Priority Data
May 19, 2003 (KR) 2003-31544
Jul. 3, 2003 (KR) 2003-44837
Apr. 2, 2004 (KR) 2004-22891

(51) Int. Cl. G11B 5/09

(52) U.S. Cl. 369/47.21; 369/59.23; 369/47.14

(57) ABSTRACT

An information storage medium having a plurality of data storage units, and an apparatus and a method of recording and/or reproducing data. The information storage medium includes a first data storage unit for recording user data and a second data storage unit for recording functional data about the use of the first data storage unit. The information storage medium may record a large amount of user data and may be formed in a small size for use in a portable electronic device.

### CROSS-REFERENCE TO RELATED APPLICATIONS

This application claims the priority of Korean Patent Application No. 2003-31544, filed on May 19, 2003, Korean Patent Application No. 2003-44837, filed on Jul. 3, 2003, and Korean Patent Application No. 2004-22891, filed on Apr. 2, 2004, in the Korean Intellectual Property Office, the disclosures of which are incorporated herein in their entirety by reference.

### BACKGROUND OF THE INVENTION

1. Field of the Invention

The present invention relates to an information storage medium having a plurality of data storing means, and an apparatus and a method of data recording and/or reproducing.

2. Description of the Related Art

Examples of an information storage medium include magnetic disks like floppy disks and hard disks, magnetic tapes, semiconductor memory chips like ROM and RAM, and optical disks like CD and DVD.

The information storage capacity of optical disks has significantly increased due to the improvement of semiconductor technologies and signal processing technologies. Because the cost of the optical disks is relatively low, wide use of optical disks has resulted.

Because of the storage capacity and costs of optical disks incorporating optical disks into a portable electronic device like a camcorder that records and/or reproduces audio data and video data is desirable.

However, there are problems in using the conventional optical disks in the portable electronic device like the camcorder. More specifically, the size and the power consumption of optical disks of 80 mm or 120 mm are too large to be used as the information storage medium of a camcorder.

Accordingly, an optical disk having a small size and an improved data recording density compared to conventional optical disks is required to provide an optical disk as the information storage medium of the portable electronic device like the camcorder.

In addition, it is desirable to increase a user data recording area by reducing the amount of data to be recorded on the optical disk other than the user data like audio/video data.

FIG. 1 illustrates an example of the structure of a conventional optical disk. Referring to FIG. 1, a burst cutting area (BCA), a lead-in zone, a data zone, and a lead-out zone are sequentially arranged in a circumference direction of the optical disk toward the outer circumference of the optical disk.

Here, a serial number of the optical disk, as an identification data, is recorded in the BCA. The lead-in zone is divided into a control data area, an information area, and an optimum power control (OPC) area, and a plurality of buffer areas.

The control data area includes the version number of the optical disk and the characteristic data of the optical disk like the size and the type of the optical disk. The information area includes data about a defect management.

Here, the data about the defect management denotes the data including the address of the defect area and the address of a replacement area in which the user data of the defect area is recorded, in the case where defects occur in a specific area of the data zone and the user data cannot be recorded in the specific area. In a broad sense, the data about the defect management includes the user data recorded in the replacement area.

The OPC area is arranged to perform a recording test in order to obtain recording conditions, and the buffer areas separate the areas having different characteristics. The user data is recorded in the data zone. The structure of the lead-out zone is similar to the structure of the lead-in zone.

In the case where an optical disk for a portable electronic device is manufactured having the same structure as the conventional optical disk, the recording capacity of the user data is limited by the data to be recorded in the lead-in zone and the lead-out zone.

For example, the BCA occupies a large area, because a code similar to a bar code is recorded in a radial direction, not a track direction. More specifically, in the case where data is recorded with a track pitch of 0.32 μm and an IT length of 74.5 nm while using a modulation code of RLL(1,7) system and occupying an area from 6 mm to 14 mm along a radius, on an optical disk having the radius of 15 mm, the recording capacity of the optical disk is about 1.26 GB. In the case where the BCA occupies 6 mm to 7 mm of the radius, the data capacity of the optical disk is reduced by 117 MB, which corresponds to about 10% of the recording capacity of the optical disk. Therefore, it is determined that an excessively large amount of the recording capacity is lost to record BCA data of a few bits.

On the other hand, the problems of the size and the power consumption of the information storage medium of a portable electronic device still occur in the case where the information recording medium used is the magnetic tape or the magnetic disk.

### SUMMARY OF THE INVENTION

According to an aspect of the present invention provides an information storage medium in which a large amount of user data is be recorded.

According to an aspect of the present invention also provides an apparatus and a method of recording data to record a large amount of user data in an information storage medium according to the present invention.

According to an aspect of the present invention an apparatus and a method of reproducing data to reproduce data from an information storage medium according to the present invention is provided.

Additional aspects and/or advantages of the invention will be set forth in part in the description which follows and, in part, will be obvious from the description, or may be learned by practice of the invention.

According to an aspect of the present invention, there is provided an information storage medium including a first data storage unit for recording user data and a second data storage unit for recording functional data about the use of the first data storage unit.

According to another aspect of the present invention, there is provided an apparatus for recording data, which records data on an information storage medium having a first data storage unit and a second data storage unit, the apparatus including a data storage unit storing data storage unit information, which denotes whether the data is recorded in the first data storage unit or the second data storage unit based on the type of the data, and a control unit receiving a data to be recorded on the information storage medium and determining whether the input data is recorded in the first data storage unit or the second data storage unit based on the data recording medium data.

According to still another aspect of the present invention, there is provided a method of recording data on an information storage medium having a first data storage unit and a second data storage unit, the method including receiving data to be recorded on the information storage medium, determining whether the input data is recorded in the first data storage unit or the second data storage unit with reference to data storage unit information, which denotes whether a data is recorded in the first data storage unit or the second data storage unit based on the type of the data, and recording the input data in the determined data storage unit.

According to yet still another aspect of the present invention, there is provided an apparatus for reproducing data, which reproduces data from an information storage medium having a first data storage unit and a second data storage unit, the apparatus including a data storage unit storing data storage unit information, which denotes whether a data is recorded in the first data storage unit or the second data storage unit based on the type of the data, and a control unit determining whether a data to be reproduced is recorded in the first data storage unit or the second data storage unit based on the data storage unit information.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an example of the structure of a conventional optical disk;

FIG. 2 is a plan view illustrating an information storage medium according to an embodiment of the present invention;

FIG. 3A illustrates an example of the structure of the optical information storage medium of FIG. 2;

FIG. 3B illustrates another example of the structure of the optical information storage medium of FIG. 2;

FIG. 4 is a plan view illustrating an information storage medium according to another embodiment of the present invention;

FIG. 5 is a sectional view illustrating the information storage medium of FIG. 4;

FIG. 6 is a plan view illustrating an example of a hub of FIG. 4;

FIG. 7 is a plan view illustrating another example of a hub of FIG. 4;

FIG. 8 is a block diagram illustrating an apparatus for recording and/or reproducing data according to an embodiment of the present invention;

FIG. 9 is a flowchart illustrating a method of recording data according to the embodiment of FIG. 2; and

FIG. 10 is a flowchart illustrating a method of reproducing data according to the embodiment of FIG. 2.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain aspects of the present invention by referring to the figures.

An information storage medium according to an embodiment of the present invention has at least two data storage units to provide a reduced size and a larger user data area than a conventional information storage medium.

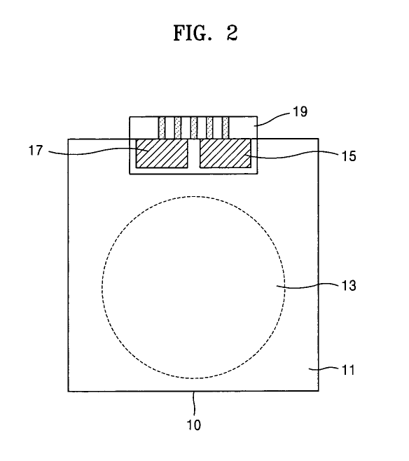

FIG. 2 is a plan view illustrating an information storage medium 10 according to an embodiment of the present invention. Referring to FIG. 2, the information storage medium 10 includes a cartridge 11, an optical data storage unit 13 as a first data storage unit, a memory chip 15 as a second data storage unit, an interface logic 17, and a slot 19.

The optical data storage unit 13 is mounted in the cartridge 11. The optical data storage unit 13 is a small sized optical disk to be used as an information storage medium for a portable electronic device; however, the optical data storage unit 13 is not limited to an optical disk.

The memory chip 15 is attached to the cartridge 11. The memory chip 15 may be an electronic memory device, for example, a flash memory.

The cartridge 11 prevents defects to the optical data storage unit 13 caused by scratches and fingerprints. In addition, the cartridge 11 includes the interface logic 17 corresponding to an interface unit of a recording and/or reproducing apparatus. The interface logic 17 facilitates data communication between the apparatus for recording and/or reproducing data in which the information storage medium 10 is loaded and the memory chip 15. The slot 19 couples with the recording and/or reproducing apparatus to provide a connection path.

Predetermined data, including the user data, is recorded in the optical data storage unit 13, and functional data about the use of the optical data storage unit 13 is recorded in the memory chip 15.

Here, the use of the optical data storage unit 13 refers to recording data in the optical data storage unit 13 or reproducing data from the optical data storage unit 13, in the recording and/or reproducing apparatus.

Examples of the functional data about the use of the optical data storage unit 13 include BCA data including a serial number of the optical data storage unit 13 as the identification data, characteristic data of the optical data storage unit 13 like the version number, the size, and the type of the optical data storage unit 13, data about defect management, and data about the recording and/or reproducing apparatus, which uses the optical data storage unit 13.

The memory chip 15 may include alternative functional data about the use of the optical data storage unit 13. The alternative functional data denotes the data that is not necessary for the use of the optical data storage unit 13 but is used for efficiently using the optical data storage unit 13 or applying reliability methods such as error correction on the recording or reproduction of data. Examples of the alternative functional data include the BCA data, data about recording speed, data about the defect management, and data about the recording and/or reproducing apparatus, which uses the optical data storage unit 13.

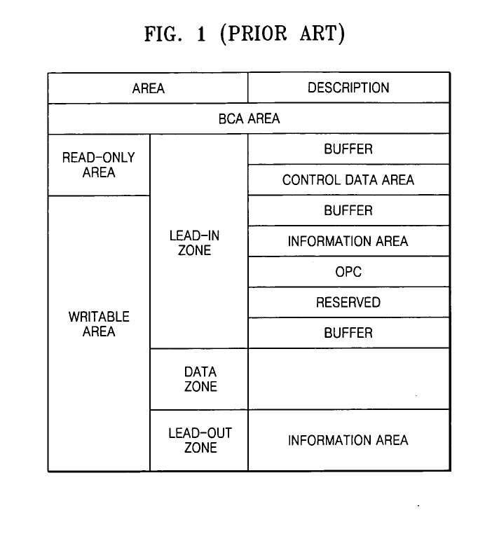

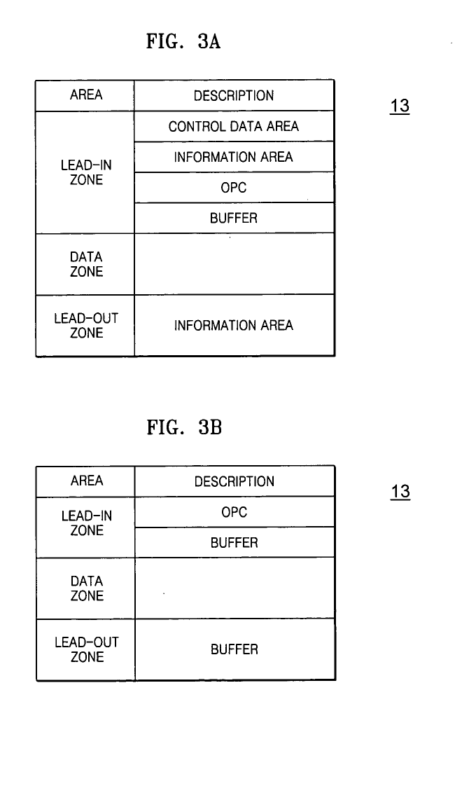

FIG. 3A illustrates an example of the structure of the optical data storage unit 13 shown in FIG. 2. When comparing the optical data storage unit 13 of FIG. 3A with the data zone of the conventional information storage medium of FIG. 1, the optical data storage unit 13 of FIG. 3A does not have a BCA in a lead-in zone.

FIG. 3B illustrates another example of the structure of the optical data storage unit 13 shown in FIG. 2. The optical data storage unit 13 of FIG. 3B does not have a BCA, a control data area, and an information area in a lead-in zone in order to create a larger user data zone.

Data not recorded in the optical data storage unit 13, for example, the BCA data, is recorded in the memory chip 15. In other words, the alternative data about the use of the optical data storage unit 13 is recorded in the memory chip 15 and not in the optical data storage unit 13, resulting in a larger user data zone in the optical data storage unit 13.

According to the structure of the optical data storage unit 13 of FIG. 3A, the alternative functional data about the use of the optical data storage unit 13 is recorded in the memory chip 15.

According to the structure of the optical data storage unit 13 of FIG. 3B, the functional data except for the OPC data and the user data is recorded in the memory chip 15.

On the other hand, since the BCA data or a portion of the data about the characteristic of the optical data storage unit 13 must not be changed, the data is protected from change after being recorded in the memory chip 15.

By recording the portion of the data about the use of the optical data storage unit 13 in the memory chip 15, a larger user data area is secured in the optical data storage unit 13 and the reliability on the data recorded in the memory chip 15 is improved. In other words, when the data about the defect management is recorded on the conventional optical disk of FIG. 1, the same defect management data is repeatedly recorded in the lead-in zone and the lead-out zone to improve reliability.

However, when the data about the defect management is recorded in the memory chip 15, the data is not required to be repeatedly recorded and the reliability on the data is improved.

In addition, data storage unit information, which denotes the data storage unit in which data is recorded or will be recorded, may be recorded in the information area in the lead-in zone of the optical data storage unit 13. The recording and/or reproducing apparatus can recognize the data storage unit to which a specific data is recorded or the data storage unit from which a specific data is reproduced between the optical data storage unit 13 and the memory chip 15, based on the data storage unit information.

On the other hand, the data storage unit information may be previously recorded in a memory (not shown) in the recording and/or reproducing apparatus, other than the optical data storage unit 13.

The information storage medium 10 according to embodiments of the present invention may use a data storage unit other than the optical data storage unit 13, for example, a magnetic tape or a magnetic disk, as the first data storage unit.

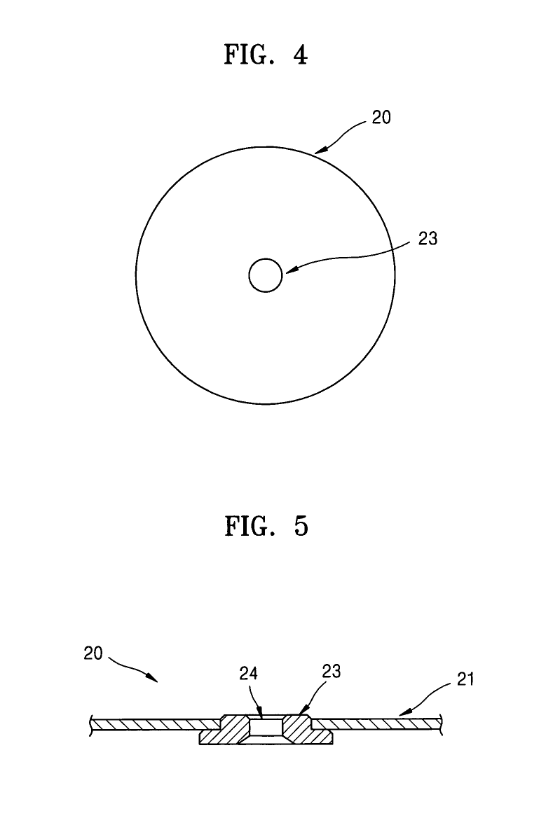

FIG. 4 is a plan view illustrating an information storage medium 20 according to another embodiment of the present invention, and FIG. 5 is a sectional view illustrating the information storage medium 20 of FIG. 4. Referring to FIG. 5, the information storage medium 20 includes an optical data storage unit 21, a hub 23, and a central hole 24 is formed at the center of the information storage medium 20.

The optical data storage unit 21 is a small-sized optical disk formed to be used as an information storage medium of a portable electronic device. However, the optical data storage unit 21 may comprise other size storage mediums and is not limited to the small-sized optical disk.

The hub 23 is formed to be chucked to a spindle motor of a recording and/or reproducing apparatus when loading the information storage medium 20 in the recording and/or reproducing apparatus.

In the case of the information storage medium 20 as shown in FIG. 5, the hub 23 is formed to record a larger amount of user data on the optical data storage unit 21.

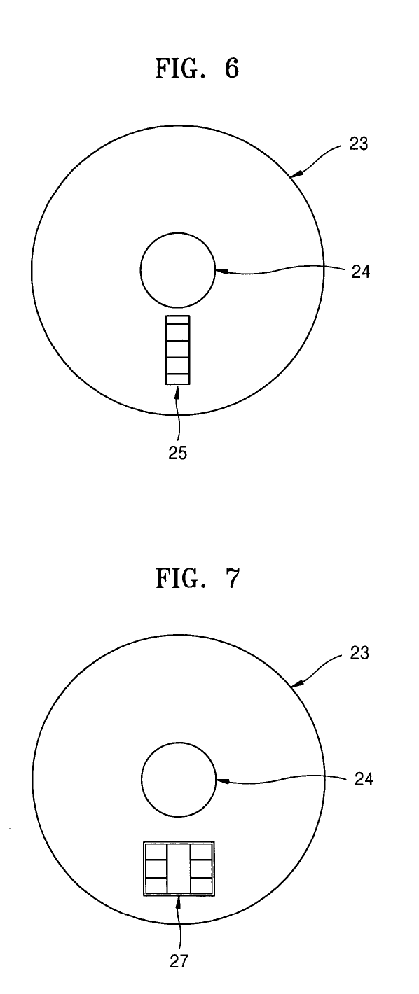

FIG. 6 is a plan view illustrating an example of the hub 23 of FIG. 4. Referring to FIG. 6, a central hole 24 is formed at the center of the hub 23, and BCA data of a bar code type, which represents the identification number of the optical data storage unit 21, is recorded at a predetermined area of the hub 23.

A conventional BCA is recorded in a bar code type in a radial direction at a predetermined area on an optical disk, so the conventional BCA occupies a large area, resulting in not recording an amount of data corresponding to the area. Accordingly, when the BCA data is recorded in the hub 23 as shown in FIG. 6, a larger user data area can be secured.

FIG. 7 is a plan view illustrating another example of the hub 23 of FIG. 4. Referring to FIG. 7, a central hole 24 is formed at the center of the hub 23, and a memory chip 27 is mounted on the hub 23. In other words, the information storage medium 20 uses the optical data storage unit 21 as a first data storage unit and the memory chip 27 as a second data storage unit, and the memory chip 27 is mounted on the hub 23.

In the case of the information storage medium 10 as shown in FIG. 2, the memory chip 15 is mounted on the cartridge 11. In the case of the information storage medium 20 shown in FIG. 4, the memory chip 27 is mounted on the hub 23. Data including the user data is recorded on the optical data storage unit 21 and the functional data about the use of the optical data storage unit 21 is recorded in the memory chip 27 of the information storage medium 20. Examples of the functional data about the use of the optical data storage unit 21 include BCA data including a serial number of the optical data storage unit 21 as the identification data, characteristic data of the optical data storage unit 21 like the version number, the size, and the type of the optical data storage unit 21, data about defect management, and data about the recording and/or reproducing apparatus, which uses the optical data storage unit 21.

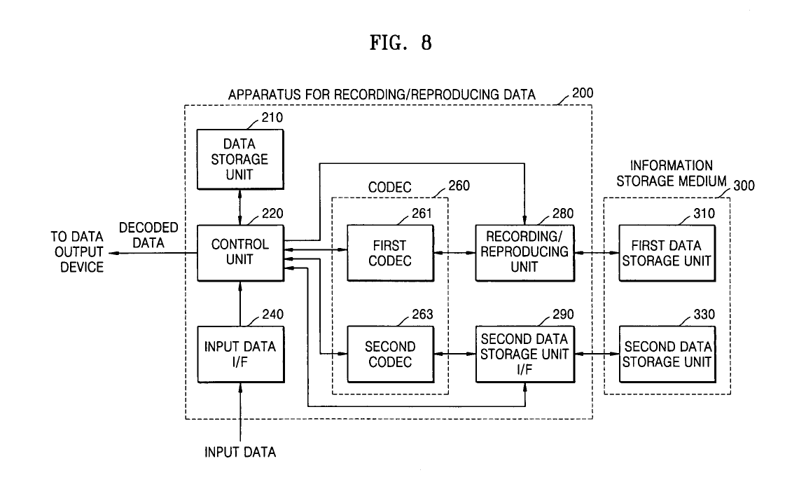

FIG. 8 is a block diagram illustrating a recording and/or reproducing apparatus 200. Referring to FIG. 8, the recording and/or reproducing apparatus 200 includes a data storage unit 210, a control unit 220, an input data interface unit 240, a codec 260, a recording/reproducing unit 280, and a second data storage unit interface unit 290.

The recording and/or reproducing apparatus 200 records data on an information storage medium 300 or reproduces data that is recorded on the information storage medium 300. In other words, the recording and/or reproducing apparatus 200 records and reproduces data on and from the information storage medium 300 or an apparatus that only reproduces data from the information storage medium 300.

The information storage medium 300 is an information storage medium according to embodiments of the present invention as shown in FIG. 2 or 4 and includes a first data storage unit 310 and a second data storage unit 330.

The first data storage unit 310 denotes an optical data storage unit and the second data storage unit 330 denotes a memory chip.

Data including the user data is recorded in the first data storage unit 310, and the functional data about the use of the first data storage unit 310 is recorded in the second data storage unit 330. More specifically, alternative functional data about the use of the first data storage unit 310 may be recorded in the second data storage unit 330.

The data storage unit 210 includes data about the recording and/or reproducing apparatus 200, for example, data about the type of the recording and/or reproducing apparatus 200. In addition, the data storage unit 210 includes data storage unit information that denotes whether a data is recorded in the first data storage unit 310 or the second data storage unit 330 based on the types of the data.

The data storage unit information is previously recorded in the data storage unit 210, or previously recorded in a predetermined area of the first data storage unit 310 and read out by the recording/reproducing unit 280 to be recorded in the data storage unit 210.

The control unit 220 determines whether the data is recorded in the first data storage unit 310 or the second data storage unit 330, or whether the data is reproduced from the first data storage unit 310 or the second data storage unit 330, based on the data storage unit information that is recorded in the data storage unit 210.

The input data interface unit 240 receives data to be recorded on the information storage medium 300 and provides the data to the control unit 220.

The codec 260 codes or modulates the data to be recorded on the information storage medium 300 into a predetermined type, or decodes or demodulates the data reproduced from the information storage medium 300 into a predetermined type.

The codec 260 includes a first codec 261 corresponding to the first data storage unit 310 and a second codec 263 corresponding to the second data storage unit 330. When the coding or modulation types for recording data in the data storage units 310 and 330 are different, both the first codec 261 and the second codec 263 are arranged to correspond to the first and second data storage units 310 and 330, respectively. However, when the coding or modulation types for recording data in the data storage units 310 and 330 are the same, only one codec may be arranged.

The recording/reproducing unit 280 records data in the first data storage unit 310 or reproduces data from the first data storage unit 310. In the case where the first data storage unit 310 is the optical data storage unit, the recording/reproducing unit 280 includes an optical pickup.

The second data storage unit interface unit 290 records data in the second data storage unit 330 or reproduces data from the second data storage unit 330.

A method of recording data according to the present invention will now be described with reference to the structure of the recording and/or reproducing apparatus 200.

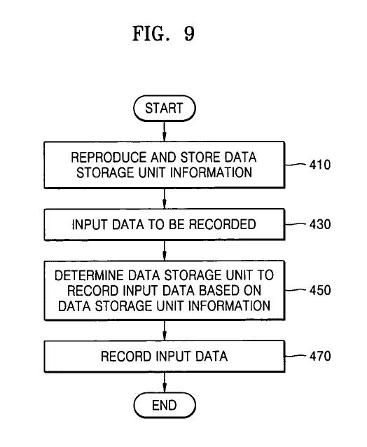

FIG. 9 is a flowchart illustrating a method of recording data according to an embodiment of the present invention. Referring to FIG. 9, when the information storage medium 300 is loaded in the recording and/or reproducing apparatus 200, the recording/reproducing unit 280 reads out the data storage unit information, which is recorded in a predetermined area of the information storage medium 300, according to the control of the control unit 220, and the data storage unit information is stored in the data storage unit 210, in operation 410. However, when the data storage unit information is previously stored in the data storage unit 210, operation 410 is omitted.

The control unit 220 receives the data to be recorded on the information storage medium 300, in operation 430. When the data to be recorded is user data, the user data is input through the input data interface unit 240, and when the data to be recorded is information data about the recording and/or reproducing apparatus 200, the data is received through the data storage unit 210. In addition, the defect management data is received through the first codec 261.

The control unit 220 determines whether the input data is recorded in the first data storage unit 310 or the second data storage unit 330, based on the data storage unit information in the data storage unit 210, in operation 450.

When the data storage unit in which the input data will be recorded is determined between the first data storage unit 310 and the second data storage unit 330, the control unit 220 outputs the input data by using the first codec 261 or the second codec 263, which corresponds to the data storage unit of recording the input data. The input data is coded or modulated in a predetermined type, and the coded or modulated input data is recorded in the first data storage unit 310 or the second data storage unit 330 through the recording/reproducing unit 280 or the second data storage unit interface unit 290, in operation 470.

A method of reproducing data from the information storage medium according to another embodiment of the present invention will now be described with reference to the structure of the recording and/or reproducing apparatus 200.

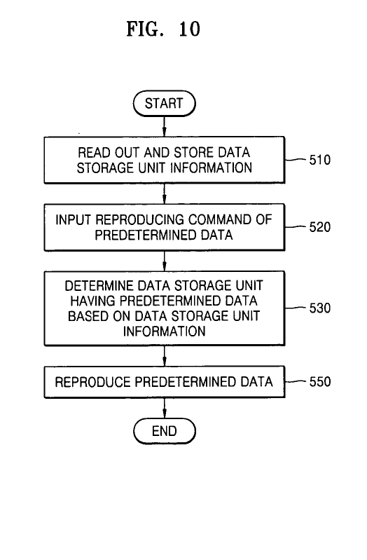

FIG. 10 is a flowchart illustrating a method of reproducing data according to the first embodiment of the present invention. When the information storage medium 300 is loaded in the recording and/or reproducing apparatus 200, the recording/reproducing unit 280 reads out the data storage unit information, which is recorded in a predetermined area of the information storage medium 300, according to the control of the control unit 220, and the data storage unit information is stored in the data storage unit 210, in operation 510. However, when the data storage unit information is previously stored in the data storage unit 210, operation 510 is omitted.

The control unit 220 receives a reproducing command corresponding to a predetermined data, in operation 520. When the data to be reproduced is user data, the data reproducing command is received from a user. However, in other cases, the control unit 220 generates a reproducing command of the predetermined data in order to reproduce the data from the information storage medium 300.

The control unit 220 determines whether the data to be reproduced is recorded in the first data storage unit 310 or the second data storage unit 330, based on the data storage unit information in the data storage unit 210, in operation 530.

When the data storage unit in which the data to be reproduced is recorded is determined between the first data storage unit 310 and the second data storage unit 330, the control unit 220 controls the recording/reproducing unit 280 or the second data storage unit interface unit 290 to reproduce the data from the first data storage unit 310 or the second data storage unit 330, respectively, in operation 550. The reproduced data is decoded or demodulated into a predetermined type by the corresponding first codec 261 or the second codec 263.

The invention can also be embodied as computer readable codes on a computer readable recording medium. The computer readable recording medium is any data storage device that can store data, which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, an information storage medium according to embodiments of the present invention includes a plurality of data storage units to record a large amount of user data. More specifically, the information storage medium according to embodiments of the present invention can be manufactured in a small size to be used as an information storage medium of a portable electronic device. In addition, the information storage medium uses the data storage units with high reliability to improve the reliability on the recorded data. Furthermore, an apparatus and a method of recording and/or reproducing data to record and/or reproduce data on and/or from the information storage medium according to embodiments of the present invention are provided.

Although a few embodiments of the present invention have been shown and described, it would be appreciated by those skilled in the art that changes may be made in this embodiment without departing from the principles and spirit of the invention, the scope of which is defined in the claims and their equivalents.

1. An information storage medium, comprising:
a first data storage unit which stores user data; and
a second data storage unit which stores functional data about a use of the first data storage unit.

2. The information storage medium of claim 1, wherein the functional data to be recorded in the second data storage unit comprises alternative functions related to the use of the first data storage unit.

3. The information storage medium of claim 1, wherein the first data storage unit is one selected from an optical disk, a magnetic tape, and a magnetic disk, and the second data storage unit is a memory chip.

4. The information storage medium of claim 1, wherein the first data storage unit is an optical disk, and the data to be recorded in the second data storage unit is at least one of BCA data including an identification number of the optical disk, data about a characteristic of the optical disk, defect management data, and data about a recording and/or reproducing apparatus that uses the information storage medium.

5. The information storage medium of claim 1, wherein the first data storage unit or the second data storage unit includes data storage unit information that determines whether a data is recorded in the first data storage unit or the second data storage unit based on a type of the data.

6. The information storage medium of claim 1, wherein the first data storage unit is an optical disk, the second data storage unit is a memory chip, and
the information storage medium further comprises a cartridge, which stores the optical disk, the memory chip is attached to an inside or an outside of the cartridge, and the cartridge includes an interface unit for data communication between the memory chip and the recording and/or reproducing apparatus.

7. The information storage medium of claim 1, wherein the first data storage unit is an optical disk, the optical disk includes a hub at an inner circumference to chuck to a driving motor of the recording and/or reproducing apparatus, and the second data storage unit is mounted on the hub.

8. An apparatus which records data on an information storage medium having a first data storage unit and a second data storage unit, the apparatus comprising:
a data storage unit storing data storage unit information, which denotes whether the data is recorded in the first data storage unit or the second data storage unit based on a type of the data; and
a control unit receiving the data to be recorded on the information storage medium and determining whether the received data is recorded in the first data storage unit or the second data storage unit based on the data storage unit information.

9. The apparatus of claim 8, wherein the control unit determines to record a predetermined type of the data including user data in the first data storage unit and to record functional data about a use of the first data storage unit in the second data storage unit.

10. The apparatus of claim 9, wherein the functional data recorded in the second data storage unit comprises alternative functions related to the use of the first data storage unit.

11. The apparatus of claim 8, wherein the first data storage unit is one selected from an optical disk, a magnetic tape, and a magnetic disk, and the second data storage unit is a memory chip.

12. The apparatus of claim 8, wherein the first data storage unit is an optical disk, and the data to be recorded in the second data storage unit is at least one of BCA data including an identification number of the optical disk, data about a characteristic of the optical disk, defect management data, and data about a recording and/or reproducing apparatus.

13. The apparatus of claim 8, wherein the data storage unit information is read from the first data storage unit and stored in the data storage unit.

14. The apparatus of claim 8, wherein when the first data storage unit is an optical disk, the apparatus includes a reading and/or reproducing unit which records the data and/or reproduces the data from the optical disk based on the control of the control unit.

15. The apparatus of claim 8, wherein when the second data storage unit is a memory chip, the apparatus includes an interface unit which records the data and/or reproduces the data from the memory chip based on the control of the control unit.

16. A method of recording data on an information storage medium having a first data storage unit and a second data storage unit, the method comprising:
receiving data to be recorded on the information storage medium;
determining whether the received data is recorded in the first data storage unit or the second data storage unit with reference to data storage unit information, which denotes whether the data is recorded in the first data storage unit or the second data storage unit based on the type of the data; and
recording the received data in the determined data storage unit.

17. The method of claim 16, wherein the determining of the data storage unit includes determining to record a predetermined type of data including user data in the first data storage unit and to record functional data about a use of the first data storage unit in the second data storage unit.

18. The method of claim 17, wherein the functional data recorded in the second data storage unit comprises alternative functions related to the use of the first data storage unit.

19. The method of claim 16, wherein the first data storage unit is one selected from an optical disk, a magnetic tape, and a magnetic disk, and the second data storage unit is a memory chip.

20. The method of claim 16, wherein the first data storage unit is an optical disk, and the data to be recorded in the second data storage unit is at least one of BCA data including an identification number of the optical disk, data about a characteristic of the optical disk, defect management data, and data about a recording and/or reproducing apparatus that uses the information storage medium.

21. The method of claim 16, wherein the data storage unit information is previously stored in the first data storage unit, and
the method further comprises:
reproducing the data storage unit information from the first data storage unit.

22. An apparatus which reproduces data from an information storage medium having a first data storage unit and a second data storage unit, the apparatus comprising:
a data storage unit storing data storage unit information, which denotes whether the data is recorded in the first data storage unit or the second data storage unit based on a type of the data; and
a control unit determining whether the data to be reproduced is recorded in the first data storage unit or the second data storage unit based on the data storage unit information.

23. The apparatus of claim 22, wherein the control unit determines to reproduce user data from the first data storage unit and to reproduce functional data about a use of the first data storage unit from the second data storage unit.

24. The apparatus of claim 23, wherein the functional data reproduced from the second data storage unit comprises alternative functions related to the use of the first data storage unit.

25. The apparatus of claim 22, wherein the first data storage unit is one selected from an optical disk, a magnetic tape, and a magnetic disk, and the second data storage unit is a memory chip.

26. The apparatus of claim 22, wherein when the first data storage unit is an optical disk, the functional data reproduced from the second data storage unit is at least one of BCA data including an identification number of the optical disk, data about a characteristic of the optical disk, defect management data, and data about a recording and/or reproducing apparatus that uses the information storage medium.

27. The apparatus of claim 22, wherein the data storage unit information is read from the first data storage unit and stored in the data storage unit.

28. The apparatus of claim 22, wherein when the first data storage unit is an optical disk, the apparatus further comprising:
a reproducing unit of reproducing data from the optical disk based on the control of the control unit.

29. The apparatus of claim 22, wherein when the second data storage unit is a memory chip, the apparatus further comprising:
an interface unit of reproducing data from the memory chip based on the control of the control unit.

30. A method of reproducing data from an information storage medium having a first data storage unit and a second data storage unit, the method comprising:
receiving a reproducing command of a predetermined data, which is recorded on the information storage medium;
determining whether the predetermined data is recorded in the first data storage unit or the second data storage unit with reference to data storage unit information, which denotes whether the data is recorded in the first data storage unit or the second data storage unit based on a type of the data; and
reproducing the predetermined data from the determined data storage unit.

31. The method of claim 30, wherein the determining of the data storage unit includes determining to reproduce user data from the first data storage unit and to reproduce functional data about a use of the first data storage unit from the second data storage unit.

32. The method of claim 31, wherein the functional data reproduced from the second data storage unit comprises alternative functions related to the use of the first data storage unit.

33. The method of claim 30, wherein the first data storage unit is one selected from an optical disk, a magnetic tape, and a magnetic disk, and the second data storage unit is a memory chip.

34. The method of claim 30, wherein when the first data storage unit is an optical disk, the data reproduced from the second data storage unit is at least one of BCA data including an identification number of the optical disk, data about a characteristic of the optical disk, defect management data, and data about a recording and/or reproducing apparatus that uses the information storage medium.

35. The method of claim 30, wherein the data storage unit information is previously stored in the first data storage unit, and the method further comprises reproducing the data storage unit information from the first data storage unit.

36. A storage medium, which is readable in a computer while having a program of realizing a method of recording data on an information storage medium having a first data storage unit and a second data storage unit, the method comprising:
receiving data to be recorded on the information storage medium;
determining whether the received data is recorded in the first data storage unit or the second data storage unit with reference to data storage unit information, which denotes whether the data is recorded in the first data storage unit or the second data storage unit based on a type of the data; and
recording the received data in the determined data storage unit.

37. A storage medium, which is readable in a computer while having a program of realizing a method of reproducing data from an information storage medium having a first data storage unit and a second data storage unit, the method comprising:
receiving a reproducing command of a predetermined data, which is recorded on the information storage medium;
determining whether the predetermined data is recorded in the first data storage unit or the second data storage unit with reference to data storage unit information, which denotes whether the data is recorded in the first data storage unit or the second data storage unit based on a type of the data; and
reproducing the predetermined data from the determined data storage unit.

38. A method of increasing a user data area on an information storage medium, comprising:
maximizing a first storage area according to a size of the information storage medium by storing a second storage area externally to the first storage area, wherein the second storage area stores functional information corresponding to the first storage area.

39. An information storage medium for use with a portable electronic device, comprising:
a cartridge having an interface to communicate with the portable electronic device;
an optical storage medium rotatably mounted in the cartridge, the optical storage medium storing user data;
a memory communicatively coupled with the cartridge, the memory storing functional data corresponding to the optical storage medium;
wherein a user data storage area on the optical storage medium is maximized by storing the functional data corresponding to the optical storage medium externally to the optical storage medium.

40. The information storage medium of claim 39, wherein the memory comprises a memory chip.

41. The information storage medium of claim 39, wherein the optical storage medium is a small size optical disk.

42. The information storage medium of claim 39, wherein the functional data comprises at least one of BCA data of the optical storage medium, data about a characteristic of the optical storage medium, defect management data, and data about a compatible portable electronic device that uses the information storage medium.

43. The information storage medium of claim 39, wherein a BCA is not stored on the optical storage medium.

44. The information storage medium of claim 39, wherein the optical storage medium comprises a lead-in zone, a data zone, and a lead-out zone.

45. The information storage medium of claim 44, wherein the lead-in zone consists essentially of a control data area, an information area, an optimum power control area, and a plurality of buffer areas.

46. The information storage medium of claim 44, wherein the lead-in zone consists essentially of an optimum power control area and a plurality of buffer areas.

47. An information storage medium for use with a portable electronic device, comprising:
an optical storage medium having a central hub defining an aperture;
wherein a user data storage area on the optical storage medium is maximized by storing functional data corresponding to the optical storage medium on the central hub.

48. The information storage medium of claim 47, wherein BCA data is stored on the hub.

49. The information storage medium of claim 47, further comprising:
a memory chip on the hub, the memory chip storing the functional data.

50. The information storage medium of claim 49, wherein the functional data comprises at least one of BCA data of the optical storage medium, data about a characteristic of the optical storage medium, defect management data, and data about a compatible portable electronic device that uses the information storage medium.
